(19) United States
(12) Patent Application Publication
(10) Pub. No.: US 2025/0091943 A1
(43) Pub. Date: Mar. 20, 2025

(54) SELF-HEATING AND SUSTAINABLE PAVEMENT SYSTEM AND METHOD

(71) Applicant: Purdue Research Foundation, West Lafayette, IN (US)

(72) Inventors: Maria Mirian Velay Lizancos, West Lafayette, IN (US); John E. Haddock, Williamsport, IN (US); Pablo Orosa Iglesias, West Lafayette, IN (US); Manuel Uriel Aspilcueta Asencios, West Lafayette, IN (US)

(21) Appl. No.: 18/885,107

(22) Filed: Sep. 13, 2024

Related U.S. Application Data
(60) Provisional application No. 63/538,563, filed on Sep. 15, 2023.

(51) Int. Cl. C04B 14/02; C04B 26/26; C04B 103/00; C04B 111/00; C04B 111/94

(52) U.S. Cl. CPC C04B 14/022; C04B 26/26; C04B 2103/0068; C04B 2111/0075; C04B 2111/94

(57) ABSTRACT

The electrically conductive pavement system includes a cold recycled asphalt mixture and a carbon black material. The carbon black material is mixed with the cold recycled asphalt mixture. The pavement system is configured to be heated. For instance, the pavement system includes a heating element and an electrical power source. The heating element may couple the electrical power source to the pavement system. In a more specific example, the heating element may include an electrical probe that include an electrically conductive cable or wire. The electrically conductive cable or wire may be selectively heated when the electrical power source is engaged. Once heated, the pavement system may have faster curing times and enhanced compaction over known pavements. The heating functionality also permits self-healing capabilities for more efficient repairs and enhanced durability. The heating functionality may also be utilized to melt ice and/or snow from a surface of the pavement system.

### CROSS REFERENCE TO RELATED APPLICATIONS

This application claims the priority benefit of U.S. Provisional Patent application No. 63/538,563, filed Sep. 15, 2023, the contents of which is incorporated herein by reference in its entirety.

### FIELD

The disclosure generally relates to pavement systems and, more particularly, to cold mix asphalt pavement systems.

### INTRODUCTION

This section provides background information related to the present disclosure which is not necessarily prior art.

Installation, repair, and maintenance of the civil infrastructure, including roads and highways of the United States, present great technical and financial challenges. The American Association of State Highway Transportation Officials (AASHTO) issued a bottom-line report in 2010 stating that $160 billion a year must be spent to maintain transportation infrastructure; however, only about $80 billion is being spent. The result is a rapidly failing transportation infrastructure. New methods of maintaining existing roads and new methods of constructing roads that would extend the useful life for the same budget dollar are needed to meet the challenges of addressing our failing infrastructure.

Cold recycling of asphalt pavements is gaining popularity due to its advantages, both economically (lower energy consumption and demand for new materials) and environmentally (reduced GHG emissions and waste generation) in comparison to traditional hot mix asphalt (HMA) techniques. However, the necessary curing time of this cold asphalt material for developing its mechanical characteristics is one of the critical limitations that makes it less extensively used than desirable.

Accordingly, there is a continuing need for a pavement system that may be more economically and efficiently utilized while also reducing its environmental impact compared to known pavement methods.

### SUMMARY

In concordance with the instant disclosure, a pavement system that may be more economically and efficiently utilized has surprisingly been discovered. Desirably, the pavement system may be more sustainable and have a lower environmental impact in comparison to known pavement systems.

The electrically conductive pavement system includes a cold recycled asphalt mixture and a carbon black material. The carbon black material is mixed with the cold recycled asphalt mixture. It is contemplated that the cold recycled asphalt mixture may instead be substituted and/or supplemented with a cold mix asphalt with virgin aggregate. In certain circumstances, the pavement system may be configured to be heated. For instance, the pavement system may include a heating element and an energy source. The heating element may couple the energy source to the pavement system. In a specific example, the energy source may include an electrical power source and/or a magnetic field. In a more specific example, the heating element may be directly coupled to an electrically conductive cable or wire or may be coupled indirectly through a magnetic field. The electrically conductive cable or wire, or magnetic field may cause the pavement system to selectively heat when the energy source is engaged. It is also contemplated the electrical power source may enable an electrode and/or a mesh material to transfer electricity to the pavement either by direct current flow or in the presence of a magnetic field. In another specific example, the electrical power source may include a generator and/or a device coupled to the local utility power grid. The electrical power source may include renewable energy sources such as a solar panel system and/or a wind power system.

The pavement system may be provided in various ways. For instance, the pavement system may be used according to a method. The method may include a step of providing the electrically conductive pavement system having a carbon black material mixed with a cold recycled asphalt mixture. Next, a heating element may be disposed in and/or adjacent to the pavement system. Afterwards, the heating element may be coupled to an energy source, such as either through direct current flow with an electrical power source, or indirectly via a magnetic field. The electrical power source may then be engaged. Next, the pavement system may be heated.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a box diagram of an electrically conductive pavement system, according to one embodiment of the present disclosure;

FIG. 2A is a schematic diagram of the mixture of the carbon black material and the cold recycled asphalt mixture coupled to an electrical power source, a controller, a heating element, further depicting the heating element disposed within the mixture of the carbon black material and the cold recycled asphalt mixture, according to one embodiment of the present disclosure;

FIG. 2B is a schematic diagram of the mixture of the carbon black material and the cold recycled asphalt mixture coupled to the electrical power source, the controller, the heating element, further depicting the heating element disposed on a top surface of the cured mixture of the carbon black material and the cold recycled asphalt mixture, according to one embodiment of the present disclosure;

FIG. 3 is a bar graph illustrating a comparison of resistivity and conductivity between samples with varying amounts of carbon black content, further depicting the addition of carbon black in cold recycled asphalt mixtures significantly reduces resistivity while increasing conductivity, according to one embodiment of the present disclosure;

FIG. 4 is a line graph illustrating experimental results of the self-heating capability of the pavement system of the present disclosure, according to one embodiment of the present disclosure; and

FIG. 5 is a flowchart of a method for using the pavement system, according to one embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

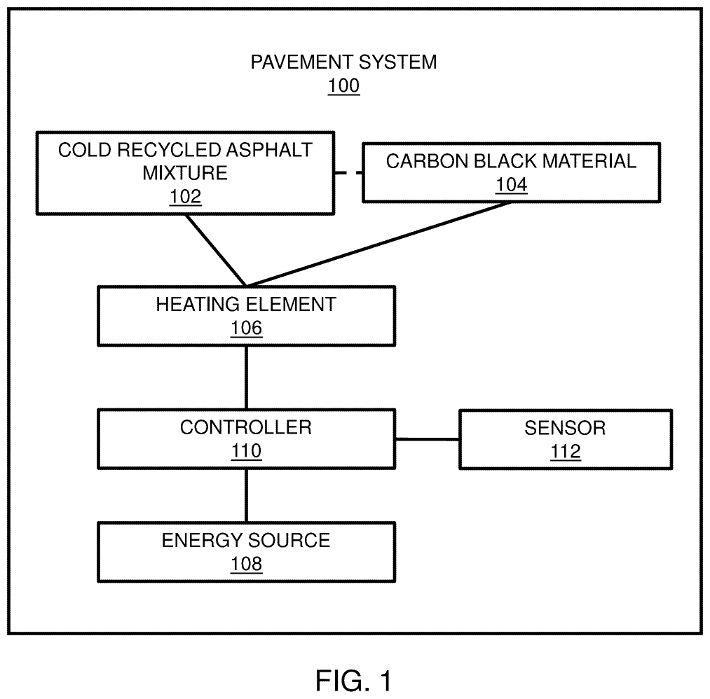

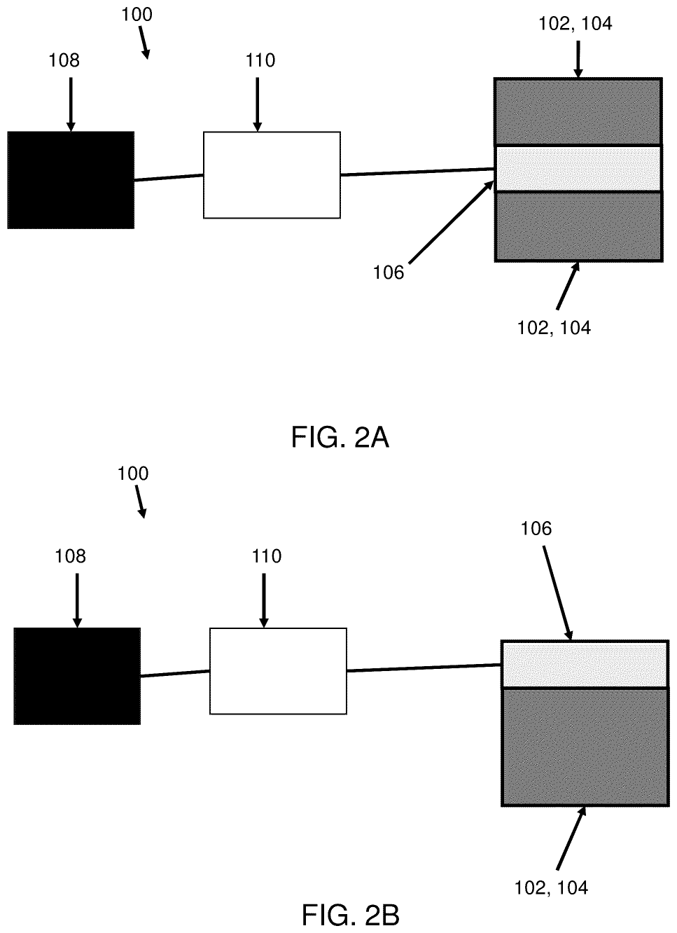

As shown in FIG. 1, the electrically conductive pavement system 100 includes a cold recycled asphalt mixture 102 and a carbon black material 104. The carbon black material 104 is coupled to the cold recycled asphalt mixture 102. It is contemplated that the cold recycled asphalt mixture may instead be substituted and/or supplemented with a cold mix asphalt with virgin aggregate. In certain circumstances, the pavement system 100 may be configured to be heated. For instance, as shown in FIG. 2A-B, the pavement system 100 may include a heating element 106 and an energy source 108. The heating element 106 may couple the energy source 108 to the mixture of the cold recycled asphalt mixture 102 and the carbon black material 104. In a specific example, the energy source 108 may include an electrical power source and/or a magnetic field. In a more specific example, the heating element 106 may be selectively heated when the energy source 108 is engaged. It is also contemplated the heating element 106 may include an electrode and/or an electrically conductive mesh material to transfer heat to the mixture of the cold recycled asphalt mixture 102 and the carbon black material 104 either through direct current flow or in the presence of the magnetic field. More specifically, as shown in FIG. 2A, the heating element 106 may be disposed within the mixture of the cold recycled asphalt mixture 102 and the carbon black material 104. For instance the heating element 106 may be disposed within the mixture of the cold recycled asphalt mixture 102 and the carbon black material 104 as the mixture cures which may provide faster curing times and enhanced compaction properties. The heating element 106 disposed within the mixture of the cold recycled asphalt mixture 102 and the carbon black material 104 as the mixture cures may also be utilized for various purposes during the service life of the pavement system 100, such as during repairs of cracks and to melt snow and/or ice. In another non-limiting example, as shown in FIG. 2B, the heating element 106 may be laid on top of and/or substantially adjacent to the mixture of the cold recycled asphalt mixture 102 and the carbon black material 104 to heat and repair a degraded section of the pavement. The heating element 106 may include an electrically conductive wire to couple the heating element 106 to the electrical power source 108. The electrical power source 108 may include a generator, a battery, and/or a device coupled to the local utility power grid. The electrical power source 108 may also include renewable energy sources such as a solar panel system and/or a wind power system. One skilled in the art may select other suitable configurations for providing the pavement system 100, within the scope of the present disclosure.

The carbon black material 104 may be provided in various ways. For instance, the carbon black material 104 may be provided from carbon companies. Alternatively, the carbon black material 104 may be pyrolyzed from waste tires. In another non-limiting example, the carbon black material 104 may be obtained from an acetylene thermal decomposition process. It is also contemplated that the carbon black material 104 may be provided from various other sources such as vegetable oil, and from a by-product in steel, plastic, and oil refining industries. In a specific example, as shown in Table 1, the type of carbon black material 104 may vary depending on its process. One skilled in the art may select other suitable ways to provide the carbon black material 104, within the scope of the present disclosure.

TABLE 1

| Carbon | BET Nitrogen | Oil Adsorption | |
|---|---|---|---|
| Black | Surface Area | Number (OAN) | Composition |
| (CB) | (m²/g) | (ml/100 g) | CB |
| CB-1 | 120-180 | 150-180 | 100 |
| CB-2 | 210-260 | 100-130 | 90-100 |
| CB-3 | 45-60 | 120-150 | 80-90 |

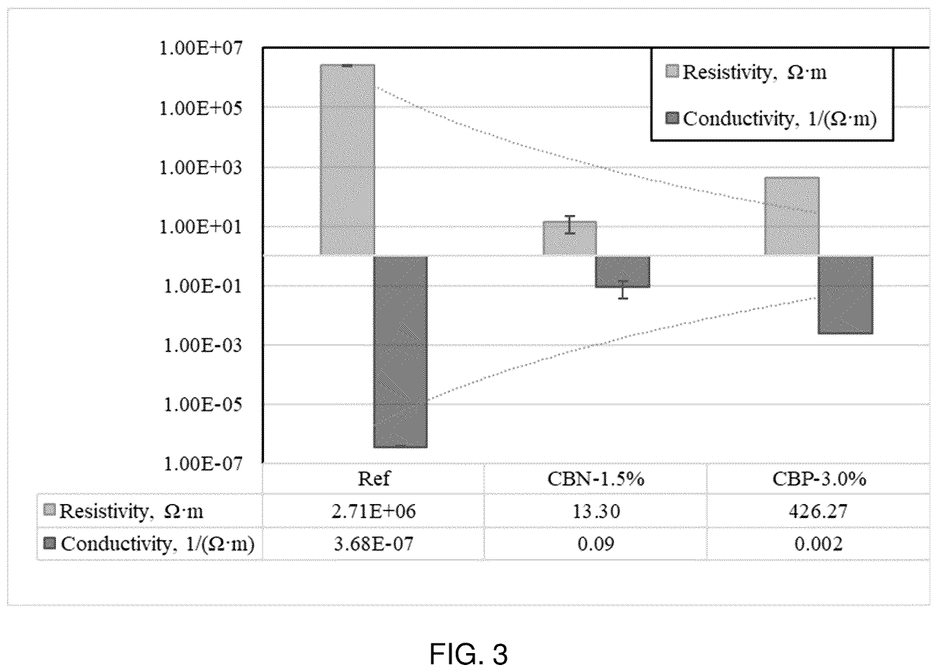

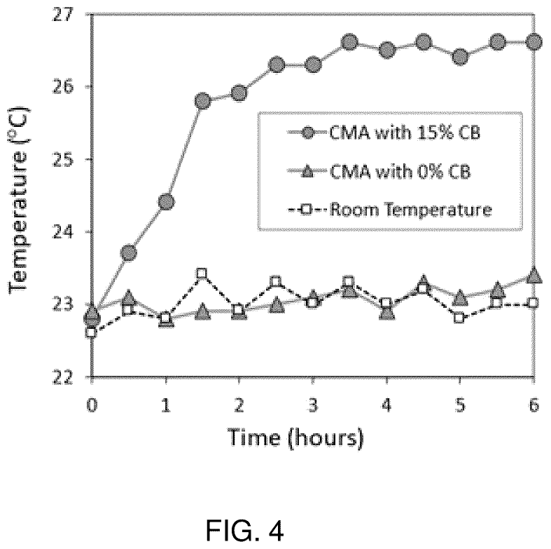

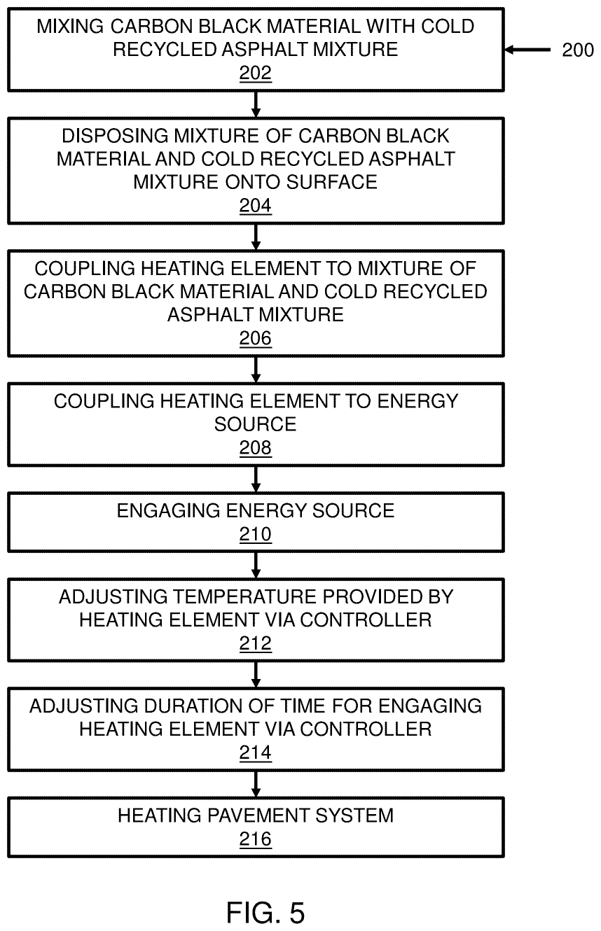

Without being bound to any particular theory, it is believed incorporating the conductive properties of carbon black with cold recycled asphalt mixture 102 may permit a self-heating capability, as evidenced in the experimental tests shown in FIG. 4. More specifically, the addition of carbon black material 104 to cold recycled asphalt mixture 102 was found to increase in temperature as energy was applied, whereas cold recycled asphalt mixture without carbon black material did not exhibit any meaningful increase in temperature. As shown in FIG. 3, the addition of carbon black material 104 in cold recycled asphalt mixtures 102 may significantly reduce the resistivity and increase the conductivity of the pavement system 100. Advantageously, this may allow for enhanced control and acceleration of the curing process for cold recycled asphalt. Additionally, the generation of heat by the heating element 106 is believed to enhance the mechanical performance of cold recycled asphalt due to high-temperature curing. More specifically, heating the cold recycling asphalt mixture during the compaction process may reduce the required energy to achieve a desired compaction level, and thus construction time of the pavement system 100 of the present disclosure may be more efficient over known pavements methods. Desirably, the incorporation of carbon black is believed to enhance the reactivation or rejuvenation of reclaimed asphalt pavement (RAP) asphalt binder.

The mixture of the cold recycled asphalt mixture 102 and the carbon black material 104 may be provided in various ways. For instance, the carbon black material 104 may less than around five percent by weight of the aggregate in the pavement system 100. In a more specific example, the carbon black material 104 may less than around one percent by weight of the aggregate in the pavement system 100. In an even more specific example, the carbon black material 104 may between around two tenths of percent to around half a percent by weight of the aggregate in the pavement system 100, depending one the density of the carbon black. One skilled in the art may select other suitable ranges for providing the carbon black material 104 in the pavement system 100, within the scope of the present disclosure.

The pavement system 100 may be provided in various ways. For instance, as shown in FIG. 4, the pavement system 100 may be used according to a method 200. The method 200 may include a step 202 of mixing a carbon black material 104 with a cold recycled asphalt mixture 102. Next, a heating element 106 may be coupled to the mixture of the carbon black material 104 and the cold recycled asphalt mixture 102. Afterwards, the heating element 106 may be coupled to an energy source 108. In a specific example, the energy source 108 may include an electrical power source and/or a magnetic field. The energy source 108 may then be engaged. Next, the pavement system 100 may be heated via the heating element 106. In a specific example, the pavement system 100 may further include a controller 110 configured to adjust the amount of energy is sent to the heating element 106 from the energy source 108, which may thereby control the heat dispersed in the pavement system 100. The controller 110 may also be configured to selectively engage the energy source 108 for a predetermined duration of time. For instance, the controller 110 may selectively engage the energy source 108 for the amount of time necessary to cure the pavement system 100 during the installation of the pavement system 100. The controller 110 may also be configured to selectively engage the energy source 108 at a predetermined time and/or condition. For instance, the controller 110 may selectively engage the energy source 108 during snowy or icy conditions. More specifically, the controller 110 may autonomously adjust the temperature provided by the heating element 106 to a predetermined temperature during adverse conditions such as when a surface of the pavement system 100 is wet, slick, frozen, etc. Provided as a non-limiting example, a user may input an instruction to the controller 110 indicating the pavement system 100 has ice on the surface. The controller 110 may then autonomously adjust the heating element 106 for a predetermined temperature and/or a duration sufficient for melting the ice. It is also contemplated the pavement system 100 may include a sensor 112 to determine when an adverse condition is present and then autonomously engage the heating element 106 to the predetermined temperature and/or duration to militate against the adverse condition. Additionally, the energy source 108 may be engaged during times when road maintenance is performed. In a particular example, the controller 110 may autonomously adjust the temperature provided by the heating element 106 to a predetermined temperature during maintenance operations, such as when repairing a portion of the pavement system 100. Desirably, in some instances damaged areas may be easily repaired by heating the section of pavement system 100 via the energy source 108 and heating element 106, thereby providing a self-healing capability.

Advantageously, the pavement system 100 may provide a more durable surface with better mechanical performance over known cold recycled asphalt mixtures. For instance, the pavement system 100 may have enhanced rutting resistance, cracking resistance, stiffness, dynamic modulus, etc. By heating the pavement system 100, it may facilitate better compaction by reducing the required time and compaction energy to meet necessary compaction parameters. Additionally, the time required to cure the pavement system 100 may be reduced by heating the pavement system 100 of the present disclosure. Desirably, the pavement service life may be extended, durations of road maintenance may be reduced, and the recycling of asphalt mixtures and carbon black may reduce carbon dioxide emissions and promote waste valorization.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. An electrically conductive pavement system comprising:
a cold mix asphalt; and
a carbon black material mixed with the cold recycled asphalt mixture.

2. The pavement system of claim 1, further comprising a heating element and an energy source wherein the heating element couples the energy source to the pavement system.

3. The pavement system of claim 1, wherein the carbon black material is recycled.

4. The pavement system of claim 3, wherein the recycled carbon black material is obtained from at least one of an acetylene thermal decomposition process, a pyrolyzed waste tire, vegetable oil, and a by-product from refining industries.

5. The pavement system of claim 1, wherein the cold mix asphalt is a cold recycled asphalt mixture.

6. The pavement system of claim 2, wherein the heating element includes at least one of an electrical probe, an electrode, and an electrically conductive mesh material.

7. The pavement system of claim 2, wherein the heating element is disposed within the mixture of the cold mix asphalt and the carbon black material.

8. The pavement system of claim 2, wherein the heating element is disposed substantially adjacent to the mixture of cold mix asphalt and the carbon black material.

9. The pavement system of claim 2, further comprising a controller that selectively adjusts a temperature provided by the heating element.

10. The pavement system of claim 9, where the controller autonomously adjusts the temperature provided by the heating element to a predetermined temperature during maintenance operations.

11. The pavement system of claim 9, where the controller autonomously adjusts the temperature provided by the heating element to a predetermined temperature during adverse conditions.

12. The pavement system of claim 11, wherein the controller adjusts a duration of time that the heating element is engaged for.

13. The pavement system of claim 2, wherein the energy source includes an electrical power source.

14. The pavement system of claim 13, wherein the electrical power source is at least one of a solar power system and a wind power system.

15. The pavement system of claim 2, wherein the energy source includes a magnetic field.

16. A method of using an electrically conductive pavement system, the method comprising the steps of:
mixing a carbon black material with a cold recycled asphalt mixture;
disposing the mixture of the carbon black material and the cold recycled asphalt mixture onto a surface;
coupling a heating element to the mixture of the carbon black material and the cold recycled asphalt mixture;
coupling the heating element to an energy source;
engaging the energy source; and
heating the pavement system.

17. The method of claim 16, further comprising a step of adjusting a temperature provided by the heating element via a controller.

18. The method of claim 16, further comprising a step of adjusting a duration of time for engaging the heating element via a controller.

19. The method of claim 16, wherein the step of coupling the heating element to the mixture of the carbon black material and the cold recycled asphalt mixture includes disposing the heating element within the mixture as it cures.

20. The method of claim 16, wherein the step of coupling the heating element to the mixture of the carbon black material and the cold recycled asphalt mixture includes disposing the heating element substantially adjacent to the mixture after the mixture has cured.
